(19) United States
(12) Patent Application Publication
(10) Pub. No.: US 2010/0114711 A1
(43) Pub. Date: May 6, 2010

(54) Social-professional website system

(76) Inventors: Robert P. Hudson, Clinton, NJ (US); Paul H. Botwick, Martinsville, NJ (US)

Correspondence Address: Deirdra M. Meagher, 24 Mine Street, Flemington, NJ, 08822, US

(21) Appl. No.: 12/290,571

(22) Filed: Oct. 31, 2008

(51) Int. Cl. G06Q 10/00

(52) U.S. Cl. 705/14.66; 705/319

(57) ABSTRACT

A social-professional website Internet system for licensed or registered professionals which: a first website and at least one host server hosting the website and providing Internet access thereto, the first website having at least sufficient software to provide: a first level of use that is a professional member level that enables a professional to use the first website to become a verified member, and, once verified as a member, and, thus, a first level user, to input personal data and professional data; a second level of use for a second level user that includes viewing features and at least some read only features for a user who is not a verified member, and, thus, a second level user; a professional information center providing at least one feature selected from the group consisting of a knowledge base, a blog, a chat room, a one-on-one chat room within the first level, a one-on-one chat room that includes the first level and the second level; means for verifying professional members approval by matching a submitting professional's data with data from a second website; and, the second website, being independent of the first website, the second website having a list of all registered or licensed professionals. Instead of a second website, stored verification data from a third party source may be used.

### BACKGROUND OF INVENTION

a. Field of Invention

The present invention relates generally to a social-professional website system for professionals, such as teachers, accountants, doctors, dentists, pharmacists, psychologists, investment advisors and professionals to offer both professional information and services and social information and services. Uniquely, the system includes two levels of users, the first being licensed or registered professionals, the second being non-licensed or non-registered users, with independent third party confirmation of an applying professional's license to qualify for first level user. The independent corroboration comes from matching the applying professional's data with another site's data, such as federal, state or organizational registration or licensing site. Alternatively, the third party registration or licensing information is inputted, stored on the website and frequently updated, and used for the approval of an applying professional to become a first level user.

b. Description of Related Art

The following patents are representative of the field pertaining to the present invention:

U.S. Pat. No. 7,428,750 B1 to Dunn et al. describes a system for managing a plurality of identities associated with a user. The invention includes a system for managing multiple credentials within the same authentication system and across federated authentication systems in such a manner that signing in with one credential allows access to content, information or services that may be associated with another credential.

U.S. Pat. No. 7,376,610 B2 to Schneider describes a computer-implemented investment management process particularly in the field of high yield corporate bond financial market consisting of five distinct process phases. In a first phase, the financial market under evaluation is researched in order to obtain all the market business information necessary for the following market evaluation phases. The next three phases are all part of the central evaluation process that will be described in more detail hereinafter. The first evaluation phase is a filtering phase where the market business information obtained from the previous research phase are filtered in order to separate useful information from non-useful information. In a following phase, the filtered business information at first is input to a subscoring process and thereafter to a scoring process. Finally, the obtained evaluation results (scores) are presented to a user in form of a recommendation displayed on a monitor or printed in paper format.

U.S. Pat. No. 7,320,018 B2 to Cannata et al. describes a system and method for providing a communication network. The system comprises a network-connected server having input and access capabilities, a site builder, a transmitter, a communicator, and memory. The site-builder receives instructions input from a first user and creates a dedicated network site based on the received instructions. The transmitter communicates the existence of the dedicated network site to a nominated second user. The communicator provides accesses to the contents of the dedicated network site by the first and second users. The memory stores information input by the first and the second user in the dedicated network site.

U.S. Pat. No. 7,290,288 B2 to Gregg et al. describes a method and system for controlling access, by an authentication server, to protected computer resources provided via an Internet Protocol network that includes storing (i) a digital identification associated with at least one client computer device, and (ii) data associated with the protected computer resources in at least one database associated with the authentication server; authenticating, by the authentication server, the digital identification forwarded by at least one access server; authorizing, by the authentication server, the at least one client computer device to receive at least a portion of the protected computer resources requested by the at least one client computer device, based on the stored data associated with the requested protected computer resources; and permitting access, by the authentication server, to the at least the portion of the protected computer resources upon successfully authenticating the digital identification and upon successfully authorizing the at least one client computer device.

U.S. Pat. No. 5,855,008 to Goldhaber et al. describes an approach for distributing advertising and other information over a computer network. Attention brokerage is the business of buying and selling (brokering) the “attention” of consumers. It can be used to provide direct, immediate payment to a consumer for paying attention to an advertisement or other information. This compensation may be used directly or indirectly to compensate the owners of content or may be used for other purposes. The link between the ad and the appropriate viewers provided by reference to a data base of digitally stored demographic profiles of potential users. Such ads may be viewed as “negatively priced” information because consumers are paid for their attention to the information. Private profiles may be maintained for different consumers and consumer information may be released only based on consumer permission. Consumers may be compensated for allowing their information to be released. Information can be routed based on demographics. A special icon or other symbol displayed on a computer screen may represent compensation and allow users to choose whether they will view an ad or other information and receive associated compensation.

United States Pending Patent Application Publication No. 2008/0235043 A1 to Goulandris et al. describes a distributed system for communicating messages between registered users of the system, each registered user communicating with the system via a user terminal, the messages relating to an original electronic document that is stored on the system and associated with one of the user terminals, the system comprising a plurality of registries, each registry having a mutual trust relationship with each of the other registries and each registry being associated with one or more user terminals; wherein each registry is connectable to a data communications network, and comprises a processing means arranged to validate the eligibility of each of its registered users' user terminals to send or receive a message relating to the stored electronic document, the processing means further being arranged to notarise a message sent from or received by the user terminal of one of its one or more registered users, the notarisation indicating the validity of the message relating to the stored document.

United States Pending Patent Application Publication No. 2007/0282730 A1 to Carpenter et al. describes systems and methods for gathering investment information of peers and/or other trusted sources and making the investment information and analysis available on a real-time basis. These systems and methods provide investment information and advisory services for individual members generated through peer research, real-time portfolio and trading sharing. Individual member account data is consolidated from a variety of data sources, and members are allowed to share the aggregate data set for the purposes of providing real-time information, insights, and investment recommendations to peers based upon individual performance, real-time trading activity, and summary member data.

United States Pending Patent Application Publication No. 2006/0259957 A1 to TAM et al. describes a system for a plurality of users to share resources with access, control and configuration based on pre-defined relationships of trust between the users of the system. A computer-based authority provides the services of authentication, identification and verification of each user within network. Processes are described that leads to the formation of an electronic community, which facilitates electronic communication and transactions in a defined manner.

United States Pending Patent Application Publication No. 2006/0106703 A1 to Del Rey et al. describes a system for facilitating client and advisor communications which may include a port to an aggregate database of a client's holdings and profile. When servicing or analyzing a client's financial needs, a financial advisor at a call center or other facility may be presented with a screen displaying some or all of the client's accounts, profile or analysis tools, collected via Internet or other sources. Other parties, including the client, may be offered access to the same, similar or related data and the financial advisor's analysis via a Web browser or other interface.

Notwithstanding the prior art, the present invention is neither taught nor rendered obvious thereby.

### SUMMARY OF INVENTION

The present invention is directed to a social-professional website Internet system for licensed or registered professionals. This system includes: A) a first website and at least one host server hosting the website and providing Internet access thereto, the first website having at least sufficient software to provide: a first level of use that is a professional member level that enables a professional to use the first website to become a verified member, and, once verified as a member, and, thus, a first level user, to input personal data and professional data; a second level of use for a second level user that includes viewing features and at least some read only features for a user who is not a verified member, and, thus, a second level user; a professional information center providing at least one feature selected from the group consisting of a knowledge base, a blog, a chat room, a one-on-one chat room within the first level, a one-on-one chat room that includes the first level and the second level; means for verifying professional members approval by matching a submitting professional's data with data from a second website; and, the second website, being independent of the first website, the second website having a list of all registered or licensed professionals.

In some preferred embodiments of the present invention social-professional website Internet system for licensed or registered professionals, the first website has sufficient software to provide a classified ad section for first level users to post classified ads.

In some preferred embodiments of the present invention social-professional website Internet system for licensed or registered professionals, the first website has sufficient software to provide classified ad response capabilities for first level users and second level users.

In some preferred embodiments of the present invention social-professional website Internet system for licensed or registered professionals, the first website has sufficient software to provide first level user profiles including creating a profile and editing profile features.

In some preferred embodiments of the present invention social-professional website Internet system for licensed or registered professionals, the first website has sufficient software to retrieve, store and present current and historical professional information and data selected from the group consisting of new technologies relating to the profession, statistics, announcements and events, and news.

In some preferred embodiments of the present invention social-professional website Internet system for licensed or registered professionals, the first website has sufficient software to provide an educational and continuing education programs and offerings.

In some preferred embodiments of the present invention social-professional website Internet system for licensed or registered professionals, the first website has sufficient software to provide an internal search feature to permit any user to search for a parameter selected from the group consisting of a professional need, a subject area, a company and an individual professional.

In some preferred embodiments of the present invention social-professional website Internet system for licensed or registered professionals, the first website has sufficient software to provide a job posting feature and a resume posting feature to assist first level users to review and seek employment opportunities.

In some preferred embodiments of the present invention social-professional website Internet system for licensed or registered professionals, the first website has sufficient software to provide a job searching feature for first level users that includes at least one search choice selected from the group consisting of job type, company name, job location and combinations thereof.

In some preferred embodiments of the present invention social-professional website Internet system for licensed or registered professionals, the first website has sufficient software to capture any particular user's incoming email address and convert it to a code for potential use by other authorized users wherein the other authorized users may rely upon the code to email the particular user without direct knowledge of that particular user's email.

In yet some other preferred embodiments wherein a social-professional website Internet system for licensed or registered professionals, includes: a website and at least one host server hosting the website and providing internet access thereto, the website having at least sufficient software to provide: a first level of use that is a professional member level that enables a professional to use the first website to become a verified member, and, once verified as a member, and, thus, a first level user, to input personal data and professional data; a second level of use for a second level user that includes viewing features and at least some read only features for a user who is not a verified member, and, thus, a second level user; a professional information center providing at least one feature selected from the group consisting of a knowledge base, a blog, a chat room, a one-on-one chat room within the first level, a one-on-one chat room that includes the first level and the second level; means for verifying professional members approval by matching a submitting professional's data with data from a second website; and, means for verifying professional member approval by matching submitting professional information with professional licensing or registration data from a separate third party source, the professional licensing or registration data from the third party source being stored in the website, and being periodically updated in the website. These embodiments may further include all of the additional features set forth above in paragraphs [0014] to [0022] inclusive.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a conceptual schematic of the communications of an embodiment of a present invention social-professional website system for licensed or registered professionals;

FIG. 2 is a conceptual schematic of the communications of another embodiment of a present invention social-professional website system for licensed or registered professionals;

FIGS. 3A and 3B collectively show a schematic of the present invention social-professional website system for licensed or registered professionals shown in FIG. 1;

FIG. 4 is a schematic of a second website shown in FIG. 3A;

FIGS. 5A and 5B collectively show a schematic of a first website shown in FIG. 3A;

FIGS. 6A and 6B collectively show a schematic of the present invention social-professional website system shown for licensed or registered professionals shown in FIG. 2;

FIG. 7 is a schematic of a second website shown in FIG. 6A;

FIGS. 8A and 8B collectively show a schematic of a first website shown in FIG. 6A;

FIG. 9 illustrates an example of a screen of one embodiment of a present invention social-professional system for a certified accountant; and,

FIG. 10 illustrates an example of a screen of one embodiment of a present invention social-professional system for a cosmetologist hairdresser and nail technologist.

### DETAILED DESCRIPTION OF THE EMBODIMENTS

Referring now in detail to the drawings wherein illustrations and examples set forth the present invention, the present invention encompasses all of the possible variations that are embodied in the appended claims.

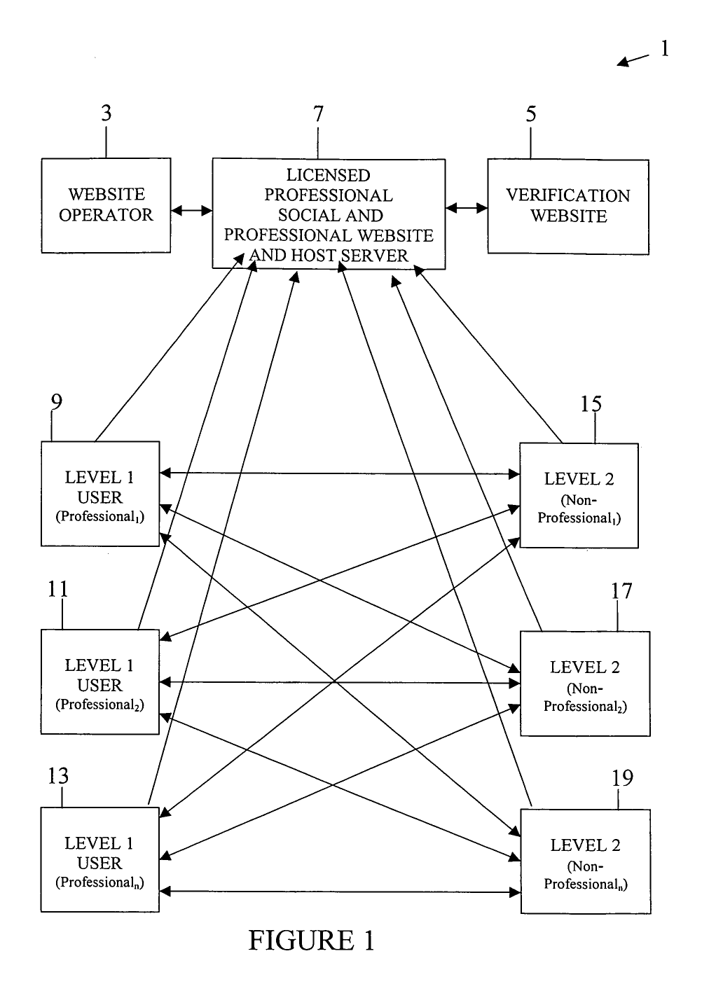

FIG. 1 is a conceptual schematic of an embodiment of the overall present invention social-professional website system 1. The social-professional website system 1 includes a licensed or registered professional social and professional website and a host server (the licensed or registered professional social and professional website, and its supporting host server, both collectively shown as element 7). A website operator 3 and the social and professional website and host server 7 are in communication with each other to enable the operator 3 to oversee content, to input various data and updated information, news, statistics, possibly, charts and other information, and to monitor and control the growth, needs and limitations of the site and server 7. Once the site is operational, users may apply for level 1 usage, that is, an approved licensed professional member, and level 2 users (non-professionals) may utilize the site with limited capabilities compared to level 1 user rights and opportunities. There is a verification website 5 that utilizes independent license and/or registration information in the level 1 admission process. Thus, when a licensed or registered professional applies for level 1 (professional membership), the verification website 5 is relied upon by website and server 7, which includes means for verifying licensed or registered professional member's approval by matching a submitting licensed or registered professional's data with data from the verification website 5. The verification website 5, and the social and professional website and host server 7 are in communication with each other on an as needed basis.

There are first level users 9, 11 and 13 and second level users 15, 17 and 19, exemplary of any total number n of users at each level. The first level users 9, 11 and 13 (level 1 users) are licensed or registered professional members who are enabled as licensed or registered professionals to use the social and professional website and host server 7 to become a verified member, and, once verified as a member, and, thus, a first level user, to input personal data and professional data and to optionally otherwise use the site for purposes, inputs, retrievals and the like that are not available to level 2 users. The second level users 15, 17 and 19 (level 2 users) are for a second level use that includes viewing features and at least some read only features for a user who is not a verified member, and, thus, a second level user.

In FIG. 1, first level users, professional₁ 9, professional₂ 11, and professionalₙ 13, are indicated where there may be any upper number of professionals. There are second level users, non-professional₁ 15, non-professional₂ 17, and non-professionalₙ 19, are indicated where there may be any upper number of non-professionals. The first level users 9, 11 and 13, and the social and professional website and host server 7 are in communication with each other. The second level users 15, 17 and 19, and the social and professional website and host server 7 are in communication with each other. Moreover, the first level users 9, 11 and 13 and the second level users 15, 17 and 19 may be in communication with each other, such as through mutually accepted one-on-one email correspondence, blogs, etc. The first level user 9, 11 and 13 may enter professional data such as services provided, contact information, recommendations, experience, bio, photo, etc. The second level user 15, 17 and 19 may not only be to contact individual licensed or registered professionals, but may be to read classified ads and respond to them, as well as to read and indicate particular needs/interests/questions in a chat room.

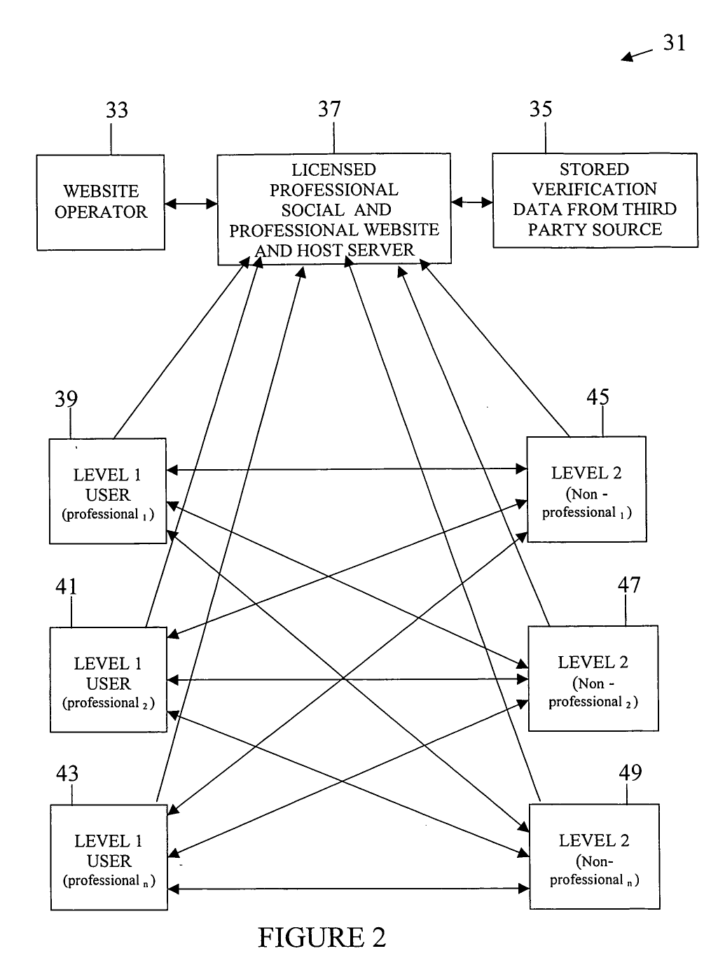

FIG. 2 is a conceptual schematic of the communications of an embodiment of a present invention social-professional website system 31. The social-professional website system 31 includes a licensed or registered professional social and professional website and a host server (both collectively known as element 37). A website operator 33 and the social and professional website and host server 37 are in communication with each other. In addition, there are first level users 39, 41 and 43 and second level users 45,47 and 49. The first level users 39, 41 and 43 are licensed or registered professional members that enable a licensed or registered professional to use the social and professional website and host server 37 to become a verified member, and, once verified as a member, and, thus, a first level user, to input personal data and professional data. The second level users 45, 47 and 49 are for a second level use that includes viewing features and at least some read only features for a user who is not a verified member, and, thus, a second level user.

In essence, to level 1 and level 2 users, these FIG. 2 embodiments may function externally in the same manner as those of FIG. 1 above. However, a verification website is not contacted each time an applicant seeks verification. Instead, there is data from a separate third party source 35 which includes means for verifying licensed or registered professional member's approval by matching a submitting licensed or registered professional's data with data in the website 37 that was previously obtained from the third party source 35. The data from the third party source 35 is updated periodically. The third party source 35 and the social and professional website and host server 7 are in communication with each other. Third party verification information may be obtained by any known method, e.g., scanning into the site from paper copy, email, periodic transmittal from another site, keypunched into the site, etc.

In FIG. 2, first level users, professional₁ 39, professional₂ 41, and professionalₙ 43, are indicated where there may be any upper number of professionals. There are second level users, non-professional₁ 45, non-professional₂ 47, and non-professionalₙ 49, are indicated where there may be any upper number of non-professionals. The first level users 39, 41 and 43, and the social and professional website and host server 3 are in communication with each other. The second level users 45, 47 and 49, and the social and professional website and host server 3 are in communication with each other. Moreover, the first level users 39, 41 and 43 and the second level users 45, 47 and 49 are in communication with each other. The first level user 39, 41 and 43 may enter professional data such as passing the professional certification examinations. The second level user 45, 47 and 49 may read these certifications and indicate in a chat room that he would like to hire the first level user for advice.

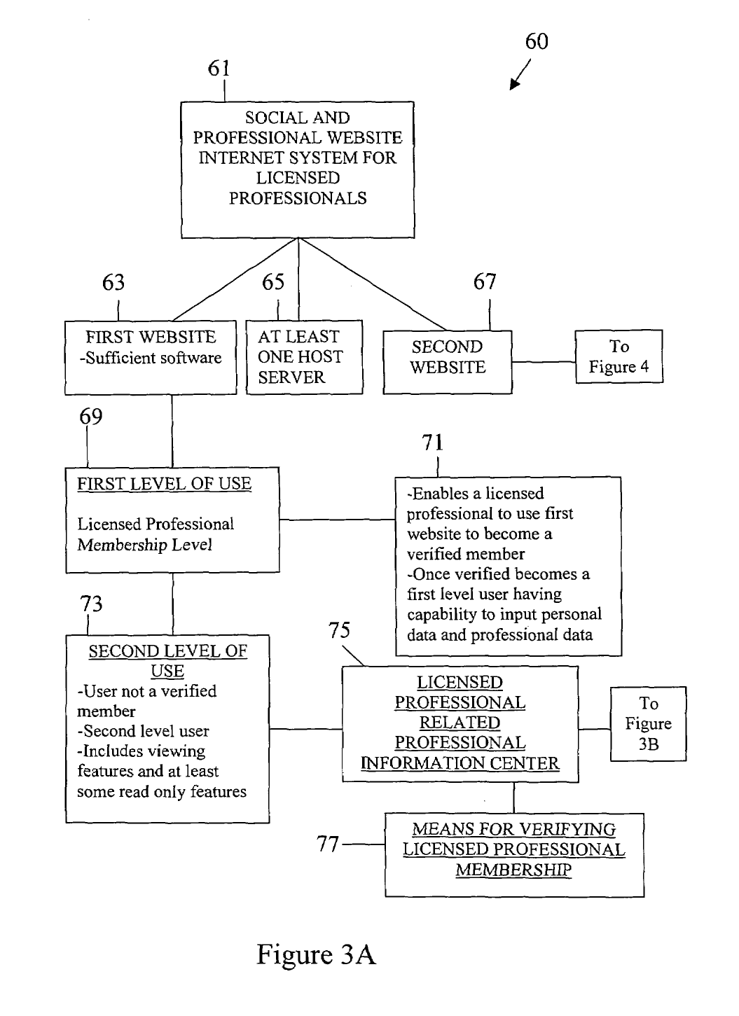

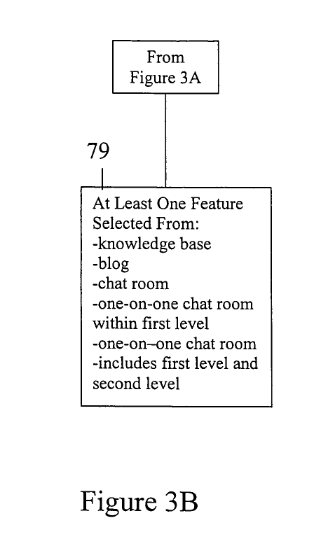

FIGS. 3A and 3B together show a schematic of the present invention social-professional website system 60 shown in FIG. 1. The social-professional website system 60 is directed to a licensed or registered professional social-professional website Internet system for licensed or registered professionals. This system includes a website 63 and at least one host server 65 hosting the website 63. The at least one host server 65 provides internet access to the website 63. The website 63 has at least sufficient software to provide a first level of use 69, a second level of use 73, a licensed or registered professional information center 75, and means for verifying the licensed or registered professional member's approval 77 by independent verification. Independent verification is from a second, independent website 67.

Referring to box 71, the first level of use 69 is a licensed or registered professional member level that enables a licensed or registered professional to use the website to become a verified member, and, once verified as a member, and, thus, a first level user, to input personal data and professional data. Referring to box 73, the second level of use for a second level user includes viewing features and at least some read only features for a user who is not a verified member, and, thus, a second level user. Referring to boxes 75 and 79, the licensed or registered professional information center provides at least one feature selected from the group consisting of a knowledge base, a blog, a chat room, a one-on-one chat room within the first level, a one-on-one chat room that includes the first level and the second level. Referring to box 77, the means for verifying licensed or registered professional member's approval is by matching a submitting licensed or registered professional's data with data from the second website 67.

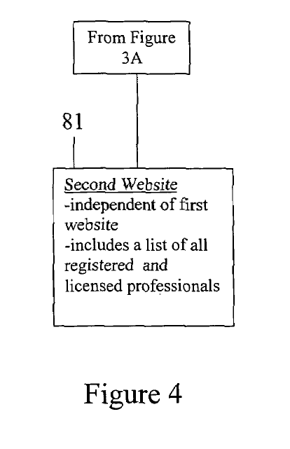

Referring now to FIG. 4, there is shown a schematic of the second website 67 shown in FIG. 3A. Box 81 describes the second website as being independent of the first website 63, and including a list of all licensed or registered professionals.

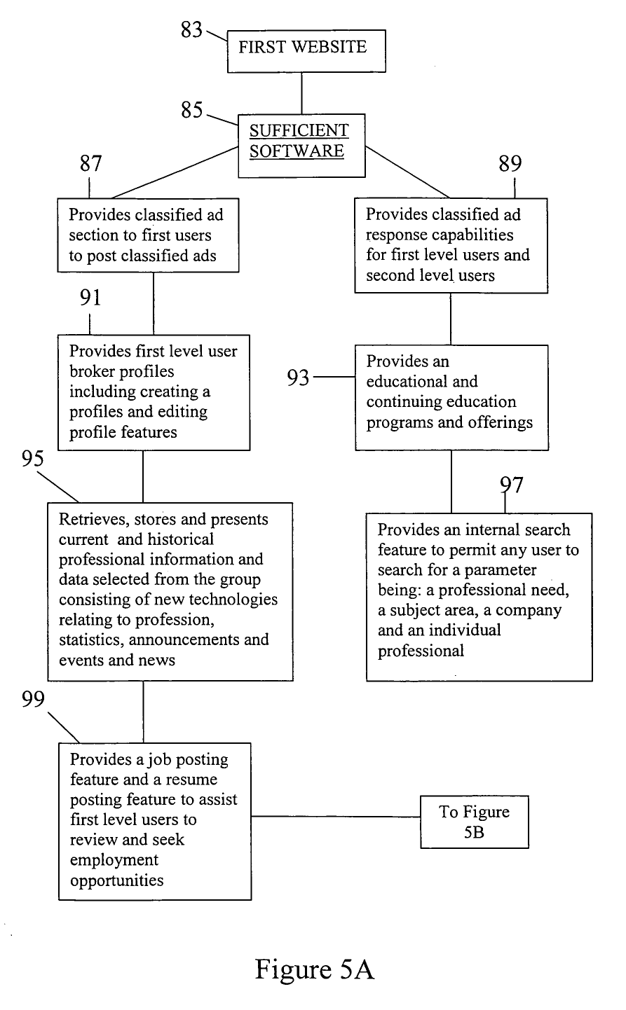

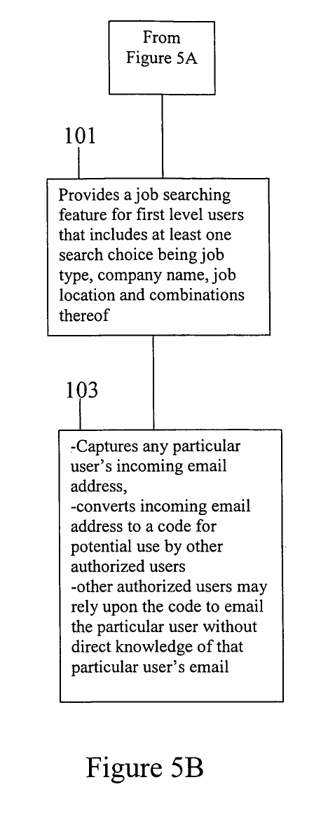

Referring to FIGS. 5A and 5B, there is shown a schematic of the first website 83 illustrating at least sufficient software 85 for capabilities of the system. Referring to box 87, the website has sufficient software to provide a classified ad section for first level users to post classified ads. Referring to box 89, the website has sufficient software to provide classified ad response capabilities for first level users and second level users. Referring to box 91, the website has sufficient software to provide first level user licensed or registered professional profiles including creating a profile and editing profile features.

Referring to box 93, the website has sufficient software to provide an educational and continuing education programs and offerings. Referring to box 95, the website has sufficient software to store and present current and historical professional information and data selected from the group consisting of new technologies relating to profession, statistics, announcements and events, and news. Referring to box 97, the website has sufficient software to provide an internal search feature to permit any user to search for a parameter selected from the group consisting of a professional need, a subject area, a company and an individual professional.

Referring to box 99, the website has sufficient software to provide a job posting feature and a resume posting feature to assist first level users to review and seek employment opportunities. Referring to box 101, the website has sufficient software to provide a job searching feature for first level users that includes at least one search choice selected from the group consisting of job type, company name, job location and combinations thereof.

Referring to box 103, the website has sufficient software to capture any particular user's incoming email address and convert it to a code for potential use by other authorized users wherein said other authorized users may rely upon said code to email said particular user without direct knowledge of that particular user's email.

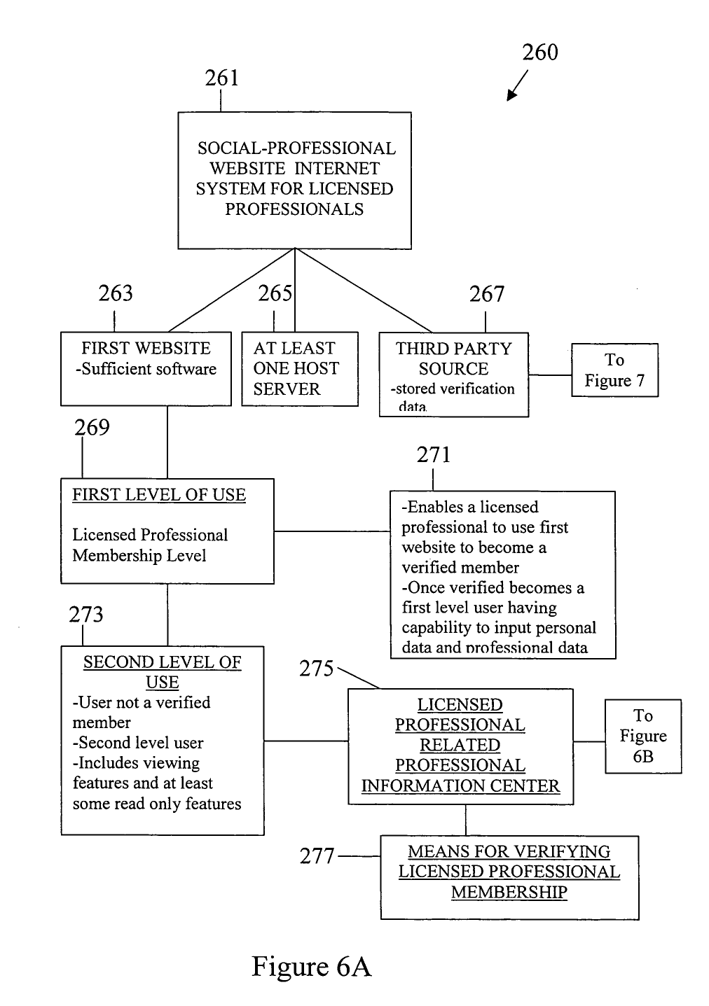

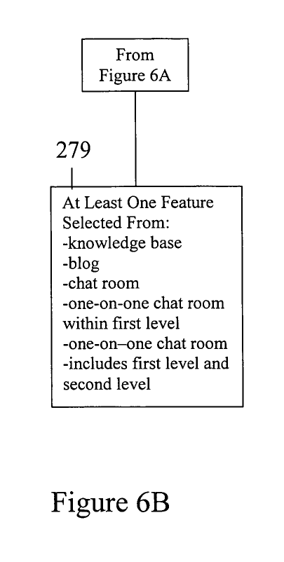

FIGS. 6A and 6B is a schematic of the present invention social-professional website system 260 shown in FIG. 2. The social-professional website system 260 is directed to a licensed or registered professional social-professional website Internet system for licensed or registered professionals. This system includes a website 263 and at least one host server 265 hosting the website 263. The at least one host server provides internet access to the website 263. The website has at least sufficient software to provide a first level of use 269, a second level of use 273, a licensed or registered professional-related information center 275, and means for verifying the licensed or registered professional member's approval 277 by independent verification. Independent verification is from data from a separate third party source 267.

Referring to box 271, the first level of use 269 is a licensed or registered professional member level that enables a licensed or registered professional to use the website to become a verified member, and, once verified as a member, and, thus, a first level user, to input personal data and professional data. Referring to box 273, the second level of use for a second level user includes viewing features and at least some read only features for a user who is not a verified member, and, thus, a second level user. Referring to boxes 275 and 279, the licensed or registered professional-related information center provides at least one feature selected from the group consisting of a knowledge base, a blog, a chat room, a one-on-one chat room within the first level, a one-on-one chat room that includes the first level and the second level. Referring to box 277, the means for verifying licensed or registered professional member's approval is by matching a submitting licensed or registered professional's data with data from a separate third party source.

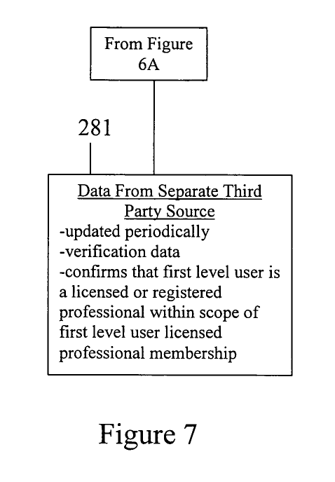

Referring now to FIG. 7, there is shown a schematic of the data from third party source 267 shown in FIG. 6A. Box 281 describes the data from third party source as being updated periodically, as being verification data, and confirms that a licensed or registered professional is within the scope of the first level user licensed or registered professional membership.

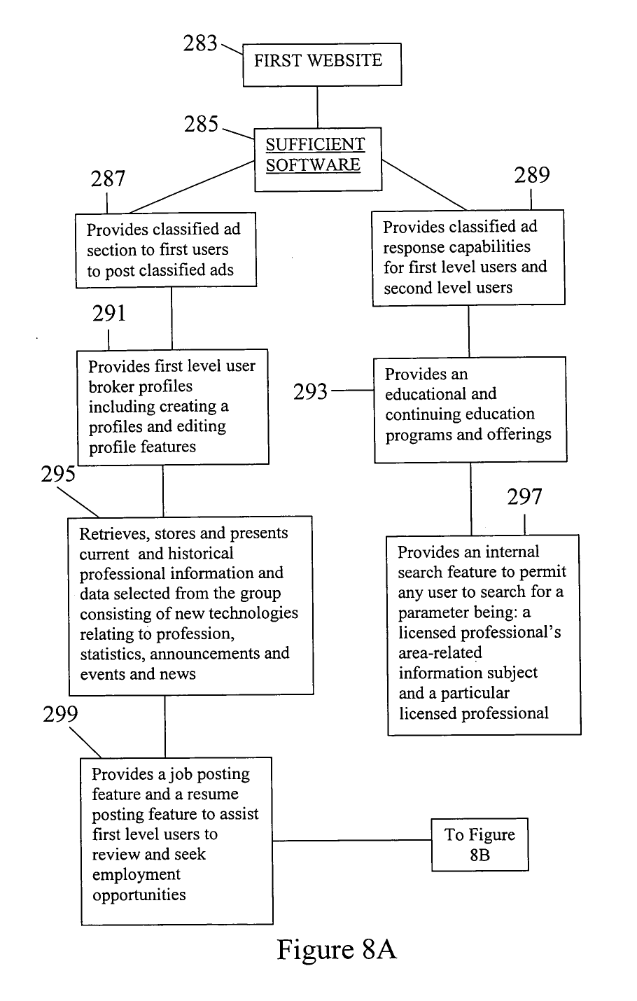

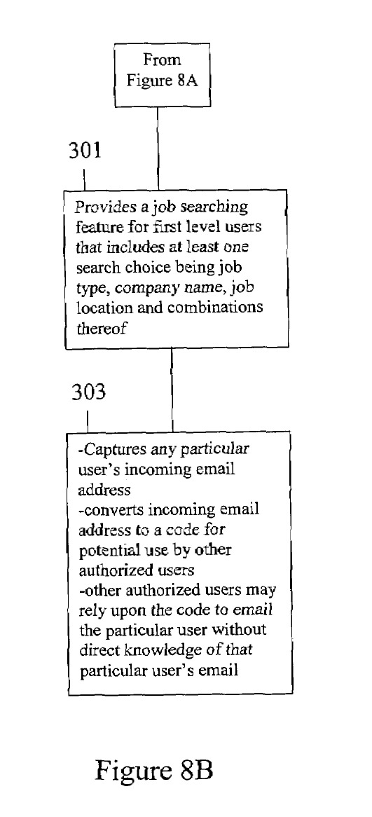

Referring to FIGS. 8A and 8B, there is shown a schematic of the first website 283 illustrating at least sufficient software 285 for capabilities of the system. Referring to box 287, the website has sufficient software to provide a classified ad section for first level users to post classified ads. Referring to box 289, the website has sufficient software to provide classified ad response capabilities for first level users and second level users. Referring to box 291, the website has sufficient software to provide first level user licensed or registered professional profiles including creating a profile and editing profile features.

Referring to box 293, the website has sufficient software to provide an educational and continuing education programs and offerings. Referring to box 295, the website has sufficient software to store and present current and historical professional information and data selected from the group consisting of new technologies relating to profession, statistics, announcements and events, and news. Referring to box 297, the website has sufficient software to provide an internal search feature to permit any user to search for a parameter selected from the group consisting of a professional need, a subject area, a company and an individual professional.

Referring to box 299, the website has sufficient software to provide a job posting feature and a resume posting feature to assist first level users to review and seek employment opportunities. Referring to box 301, the website has sufficient software to provide a job searching feature for first level users that includes at least one search choice selected from the group consisting of job type, company name, job location and combinations thereof.

Referring to box 303, the website has sufficient software to capture any particular user's incoming email address and convert it to a code for potential use by other authorized users wherein said other authorized users may rely upon said code to email said particular user without direct knowledge of that particular user's email.

As can now be seen, the present invention system serves licensed or registered professionals, clients and the public in many diverse ways, including opportunities for licensed or registered professional's services, for licensed or registered professional selection, for data procurement, licensed or registered professional upward mobility, new job opportunities, social interactions, professional discourse, chats, emails, blogs, classifieds, products, advertising, events, news, advisors, profiles, continuing education, rolling surveys, charts and histories, all with unique independently verified membership acceptance.

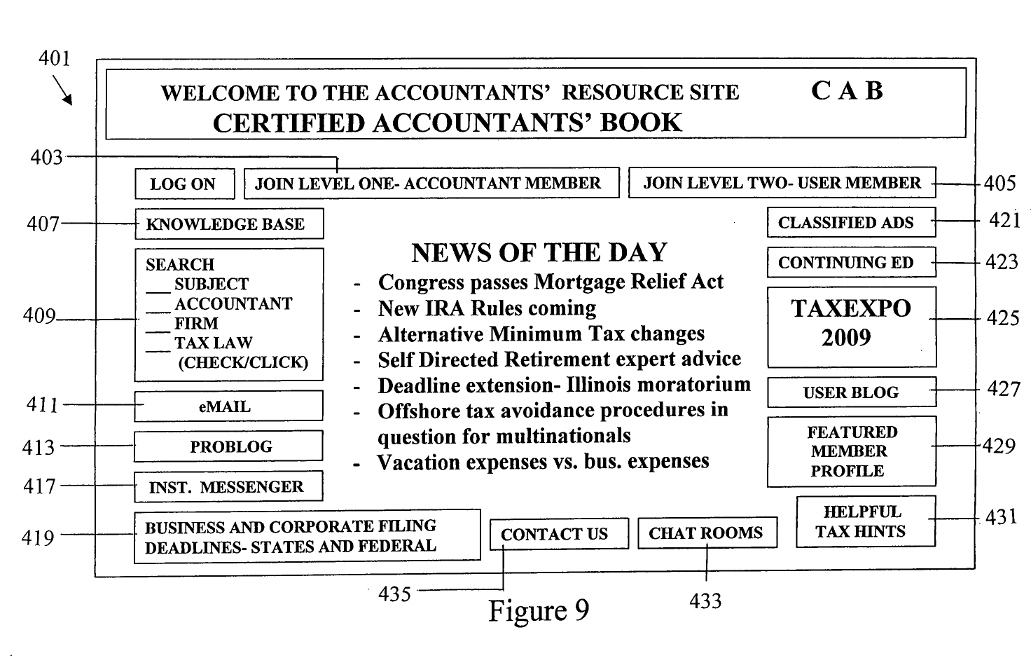

FIG. 9 illustrates an example of a screen of one embodiment of a present invention social-professional system for a certified accountant. Thus, FIG. 9 illustrates the home page screen 401 for a present invention system website called the “CERTIFIED ACCOUNTS BOOK”. The home page screen has various further screen selections, as well as “NEWSOF THE DAY”. The further selections provide a user with many options, including LOG ON or JOIN. The JOIN option includes join level one—accountant member 403 or join lever two—user member 405. There is a knowledge base selection 407. The knowledge base selection may provide subsequent screens with forums chosen, with mentoring chosen, with various surveys chosen, with knowledge base searching chosen. There is a search selection 409 which provides the options of subject, accountant, firm and tax law. Thus, when an accountant is selected for a search, a subsequent screen shows a “find a professional” selection. There is an email selection 411 for another screen to email. As explained herein above, a user does not have to know the email address to send emails. There is a selection for another page screen showing a professional blog. 413, as well as a selection for another screen showing a user blog 427. There is a selection for another page screen showing instant message capabilities 417. There is a selection for another screen on business and corporate filing deadlines for states and federal 419.

There is a selection for another page screen showing classified ads 421 and further search by choices. The continuing ed selection 423 provides a user with educational courses and means to sign up. The TAXEXPO 2009 selection 425 provides information on the most recent tax show. The featured member profile 429 is a selection showing a subsequent screen having full profile for members with windows of information. There are selections for helpful tax hints 431 and chat rooms 433. There is a selection for another page screen showing a contact us option 435.

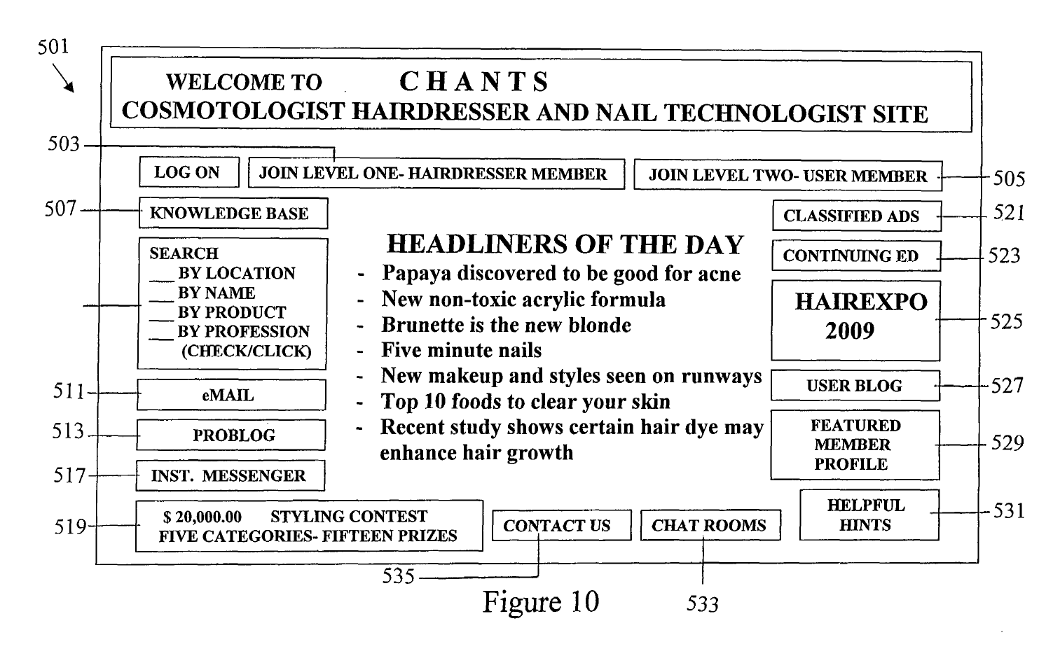

FIG. 10 illustrates an example of a screen of one embodiment of a present invention social-professional system for a cosmetologist hairdresser and nail technologist. Thus, FIG. 10 illustrates the home page screen 501 for a present invention system website called the “COSMETOLOGIST HAIRDRESS AND NAIL TECHNOLOGY SITE. The home page screen has various further screen selections, as well as “HEADLINERS OF THE DAY”. The further selections provide a user with many options, including LOG ON or JOIN. The JOIN option includes join level one—hairdresser member 503 or join lever two—user member 505. There is a knowledge base selection 507. The knowledge base selection may provide subsequent screens with forums chosen, with mentoring chosen, with various surveys chosen, with knowledge base searching chosen. There is a search selection 509 which provides the options of location, name, product and profession. There is an email selection 511 for another screen to email. As explained herein above, a user does not have to know the email address to send emails. There is a selection for another page screen showing a professional blog. 513, as well as a selection for another screen showing a user blog 527. There is a selection for another page screen showing instant message capabilities 517. There is a selection for another screen on a styling contest 519.

There is a selection for another page screen showing classified ads 521 and further search by choices. Thus, when an accountant is selected for a search, a subsequent screen shows a “find a professional” selection. The continuing ed selection 523 provides a user with educational courses and means to sign up. The HAIREXPO 2009 selection 525 provides information on the most recent cosmetology show. The featured member profile 529 is a selection showing a subsequent screen having full profile for members with windows of information. There are selections for helpful tax hints 531 and chat rooms 533. There is a selection for another page screen showing a contact us option 535.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, the website of the present invention system may include video streaming, video conferencing, instant messenger phoning and other features currently or about to become available on internet web sites.

What is claimed is:

1. A social-professional website Internet system for licensed or registered professionals, comprising:
A) a first website and at least one host server hosting said website and providing internet access thereto, said first website having at least sufficient software to provide:
a) a first level of use that is a professional member level that enables a professional to use said first website to become a verified member, and, once verified as a member, and, thus, a first level user, to input personal data and professional data;
b) a second level of use for a second level user that includes viewing features and at least some read only features for a user who is not a verified member, and, thus, a second level user;
c) a professional information center providing at least one feature selected from the group consisting of a knowledge base, a blog, a chat room, a one-on-one chat room within said first level, a one-on-one chat room that includes said first level and said second level;
d) means for verifying professional members approval by matching a submitting professional's data with data from a second website; and,
B) said second website, being independent of said first website, said second website having a list of all registered or licensed professionals.

2. A social-professional website Internet system for licensed or registered professionals of claim 1 wherein said first website has sufficient software to provide a classified ad section for first level users to post classified ads.

3. A social-professional website Internet system for licensed or registered professionals of claim 2 wherein said first website has sufficient software to provide classified ad response capabilities for first level users and second level users.

4. A social-professional website Internet system for licensed or registered professionals of claim 1 wherein said first website has sufficient software to provide first level user profiles including creating a profile and editing profile features.

5. A social-professional website Internet system for licensed or registered of claim 1 wherein said first website has sufficient software to retrieve, store and present current and historical professional information and data selected from the group consisting of new technologies relating to the profession, statistics, announcements and events, and news.

6. A social-professional website Internet system for licensed or registered professionals of claim 1 wherein said first website has sufficient software to provide an educational and continuing education programs and offerings.

7. A social-professional website Internet system for licensed or registered professionals of claim 1 wherein said first website has sufficient software to provide an internal search feature to permit any user to search for a parameter selected from the group consisting of a professional need, a subject area, a company and an individual professional.

8. A social-professional website Internet system for licensed or registered professionals of claim 1 wherein said first website has sufficient software to provide a job posting feature and a resume posting feature to assist first level users to review and seek employment opportunities.

9. A social-professional website Internet system for licensed or registered professionals of claim 1 wherein said first website has sufficient software to provide a job searching feature for first level users that includes at least one search choice selected from the group consisting of job type, company name, job location and combinations thereof.

10. A social-professional website Internet system for licensed or registered professionals of claim 1 wherein said first website has sufficient software to capture any particular user's incoming email address and convert it to a code for potential use by other authorized users wherein said other authorized users may rely upon said code to email said particular user without direct knowledge of that particular user's email.

11. A social-professional website Internet system for licensed or registered professionals, comprising:
a website and at least one host server hosting said website and providing internet access thereto, said website having at least sufficient software to provide:
a) a first level of use that is a professional member level that enables a professional to use said first website to become a verified member, and, once verified as a member, and, thus, a first level user, to input personal data and professional data;
b) a second level of use for a second level user that includes viewing features and at least some read only features for a user who is not a verified member, and, thus, a second level user;
c) a professional information center providing at least one feature selected from the group consisting of a knowledge base, a blog, a chat room, a one-on-one chat room within said first level, a one-on-one chat room that includes said first level and said second level;
d) means for verifying professional members approval by matching a submitting professional's data with data from a second website; and,
e) means for verifying professional member approval by matching submitting professional information with professional licensing or registration data from a separate third party source, said professional licensing or registration data from said third party source being stored in said website, and being periodically updated in said website.

12. A social-professional website Internet system for licensed or registered professionals of claim 11 wherein said website has sufficient software to provide a classified ad section for first level users to post classified ads.

13. A social-professional website Internet system for licensed or registered professionals of claim 12 wherein said website has sufficient software to provide classified ad response capabilities for first level users and second level users.

14. A social-professional website Internet system for licensed or registered professionals of claim 11 wherein said website has sufficient software to provide first level user profiles including creating a profile and editing profile features.

15. A social-professional website Internet system for licensed or registered of claim 11 wherein said first website has sufficient software to retrieve, store and present current and historical professional information and data selected from the group consisting of new technologies relating to the profession, statistics, announcements and events, and news.

16. A social-professional website Internet system for licensed or registered professionals of claim 11 wherein said first website has sufficient software to provide an educational and continuing education programs and offerings.

17. A social-professional website Internet system for licensed or registered professionals of claim 11 wherein said first website has sufficient software to provide an internal search feature to permit any user to search for a parameter selected from the group consisting of a professional need, a subject area, a company and an individual professional.

18. A social-professional website Internet system for licensed or registered professionals of claim 11 wherein said first website has sufficient software to provide a job posting feature and a resume posting feature to assist first level users to review and seek employment opportunities.

19. A social-professional website Internet system for licensed or registered professionals of claim 11 wherein said first website has sufficient software to provide a job searching feature for first level users that includes at least one search choice selected from the group consisting of job type, company name, job location and combinations thereof.

20. A social-professional website Internet system for licensed or registered professionals of claim 11 wherein said first website has sufficient software to capture any particular user's incoming email address and convert it to a code for potential use by other authorized users wherein said other authorized users may rely upon said code to email said particular user without direct knowledge of that particular user's email.
